(19) United States
(12) Patent Application Publication
(10) Pub. No.: US 2015/0031484 A1
(43) Pub. Date: Jan. 29, 2015

(54) TENSIONER WITH SINGLE TORSION SPRING HAVING MULTIPLE NESTED WINDINGS

(71) Applicant: James Kevin Lindstrom, Springdale, AR (US)

(72) Inventor: James Kevin Lindstrom, Springdale, AR (US)

(73) Assignee: DAYCO IP HOLDINGS, LLC, Springfield, MO (US)

(21) Appl. No.: 13/951,735

(22) Filed: Jul. 26, 2013

(51) Int. Cl. F16H 7/12

(52) U.S. Cl. CPC F16H 7/12
USPC 474/117

(57) ABSTRACT

A tensioner is disclosed that may be part of a power system where the tensioner provides tension to an endless power transmitting element such as a belt, chain, or other continuous loop. The tensioner includes an arm that is rotatable about a first axis and a spring. The spring has at least one inner winding, an outer winding, and a transition zone. The outer winding has an outer coil that defines an outer diameter. The inner winding has an inner coil that defines an inner diameter. The inner diameter of the inner coil is less than the outer diameter of the outer coil such that at least a portion of the inner winding is received by the outer winding. The outer winding and the inner winding of the spring both urge the arm to rotate about the first axis and into tensioning engagement with the power transmitting element.

### TECHNICAL FIELD

The present invention relates generally to tensioners and more particularly to a tensioner utilizing a single torsion spring having multiple windings arranged in a nested configuration.

### BACKGROUND

The main purpose of a belt tensioner that automatically responds to fluctuations in the movements of an endless belt is to prolong the life of the belt itself, or of engine components such as accessories operating in conjunction with the belt. Belt tensioners are typically used in front-end accessory drives in an automobile engine. A front-end accessory drive often includes pulley sheaves for each accessory the belt is required to power, such as the air conditioner, water pump, fan and alternator. Each of these accessories requires varying amounts of power at various times during operation. These power variations, or torsionals, create a slackening and tightening situation of each span of the belt. The belt tensioner is utilized to absorb these torsionals through use of an internally mounted torsion spring. The torsion spring is operatively coupled between an arm and a base housing of the belt tensioner so as to force a distal end of the arm against the belt and, in turn, to provide sufficient tension force, via a pulley, on the belt as required.

In some instances, the belt may experience torsional loads that are large enough to rotate the distal end of the arm of the belt tensioner away from the belt, which causes tension in the belt to be temporarily reduced. In order to counteract the large torsional loads that rotate the distal end of the arm of the belt tensioner away from the belt, the force exerted by the torsion spring in the belt tensioner is increased. The force exerted by the torsion spring may be increased by thickening the coils of the torsion spring, and/or by adding coils to the torsion spring. However, thickening the coils of the torsion spring increases the width of the torsion spring, and adding coils to the torsion spring increases the height of the torsion spring. Increasing the width or height of the torsion spring will increase the amount of packaging space required by the belt tensioner. Therefore, it may be challenging to package the belt tensioner, especially in applications where packaging space is limited.

### SUMMARY

In one aspect, a tensioner is disclosed that includes a single torsion spring having multiple windings arranged in a nested configuration. Specifically, the windings may have graduated coil diameters, where one of the windings fits within another winding that that has a slightly larger coil diameter. Arranging the windings of the torsion spring in a nested configuration will result in a reduced amount of packaging space needed by the tensioner.

In one embodiment, a tensioner including an arm and a spring is disclosed. The arm is rotatable about a first axis, and has an arm arbor. The spring is coupled to the arm arbor. The spring has an outer winding, at least one inner winding, and a transition zone. The transition zone connects the inner winding with the outer winding. The outer winding has an outer coil that defines an outer diameter. The inner winding has an inner coil that defines an inner diameter. The inner diameter of the inner coil is less than the outer diameter of the outer coil such that at least a portion of the inner winding of the spring is received by the outer winding of the spring. The outer winding and the inner winding of the spring both urge the arm to rotate about the first axis into tensioning engagement with a power transmitting element. The inner winding and the outer winding of the spring may be connected to one another either a series configuration or a parallel configuration.

In another embodiment, the tensioner includes a support member for receiving the arm arbor and the spring. The support member is stationary and includes a pivot shaft that defines the first axis. The arm is rotatably mounted to the pivot shaft.

In one embodiment, the inner winding and the outer winding are connected to one another in the series configuration. An end portion of the inner winding is fixedly attached to the support member, and an end portion of the outer winding is connected to the arm arbor.

In another embodiment, the inner winding and the outer winding are connected to one another in the parallel configuration. The support member includes a retaining feature that fixedly attaches a portion of the spring to the support member. The end portion of the inner winding is connected to the arm arbor, and the end portion of the outer winding is connected to the arm arbor.

In yet another embodiment, a tensioner is disclosed that may be part of a power system where the tensioner provides tension to an endless power transmitting element. The tensioner includes a support member including a pivot shaft that defines a first axis, and an arm. The arm has an arm arbor that is mounted on the pivot shaft for rotatable movement of the arm about the first axis. The arm arbor defines a cavity. The tensioner also includes a spring received in the cavity of the arm arbor and coupled to the arm. The spring comprises an outer winding, at least one inner winding, and a transition zone. The transition zone connects the inner winding with the outer winding. A portion of the spring bends between the inner winding and the outer winding in the transition zone. The inner winding has an outer coil that includes an outer diameter. The inner winding has an inner coil that includes an inner diameter. The inner diameter of the inner coil is less than the outer diameter of the outer coil such that at least a portion of the inner winding of the spring is received by the outer winding of the spring. The outer winding and the inner winding of the spring both urge the arm arbor to rotate about the first axis into tensioning engagement with a power transmitting element. The support member receives the arm arbor and the spring. The inner winding and the outer winding of the spring may be connected to one another either the series configuration or the parallel configuration.

### BRIEF DESCRIPTION OF THE DRAWINGS

FIG. 1 is a front view of an engine which utilizes an embodiment of a tensioner.

FIG. 2 is an exploded perspective view of an embodiment of a tensioner.

FIG. 3 is a side, partial cross-sectional view of a portion of the tensioner of FIG. 2 taken along line 3-3.

FIG. 4 is a cross-sectional view of the tensioner of FIG. 3 taken along line 4-4.

FIG. 5 is a cross-sectional view of the tensioner of FIG. 3 taken along line 5-5.

FIG. 6 is an exploded perspective view of another embodiment of a tensioner.

FIG. 7 is a side, partial cross-sectional view of a portion of the tensioner of FIG. 6 taken along line 7-7.

FIG. 8 is a cross-sectional view of the tensioner of FIG. 7 taken along line 8-8.

FIG. 9 is a cross-sectional view of the tensioner of FIG. 7 taken along line 9-9.

FIG. 10 is a cross-sectional view of an alternative embodiment of the tensioner shown in FIG. 8.

### DETAILED DESCRIPTION

The following detailed description will illustrate the general principles of the invention, examples of which are additionally illustrated in the accompanying drawings. In the drawings, like reference numbers indicate identical or functionally similar elements.

Disclosed herein is a tensioner including a single torsion spring having multiple windings arranged in a nested configuration. Specifically, the windings may have graduated coil diameters, where one of the windings fits within another winding that that has a slightly larger coil diameter. The windings operate together to urge an arm of the tensioner into tensioning engagement with a power transmitting element. The windings of the torsion spring may be connected together in either a series configuration or a parallel configuration, where each winding urges an arm of the tensioner to rotate about an axis and into tensioning engagement with an endless power transmitting element. The tensioner is typically part of a power system, where the tensioner provides tension to the power transmitting element. The power transmitting element may be, for example, a belt, chain, or other continuous loop that is in a system driven by at least one source and that also drives at least one accessory. Tensioning a slack power transmitting element is an unwinding of a wound-up tensioner, which will be referred to herein as the tensioning direction T. In the opposite direction, referred to herein as the winding direction W, a winding up of the tensioner occurs in response to a prevailing force of the power transmitting element, which is tightening in the span where the tensioner resides.

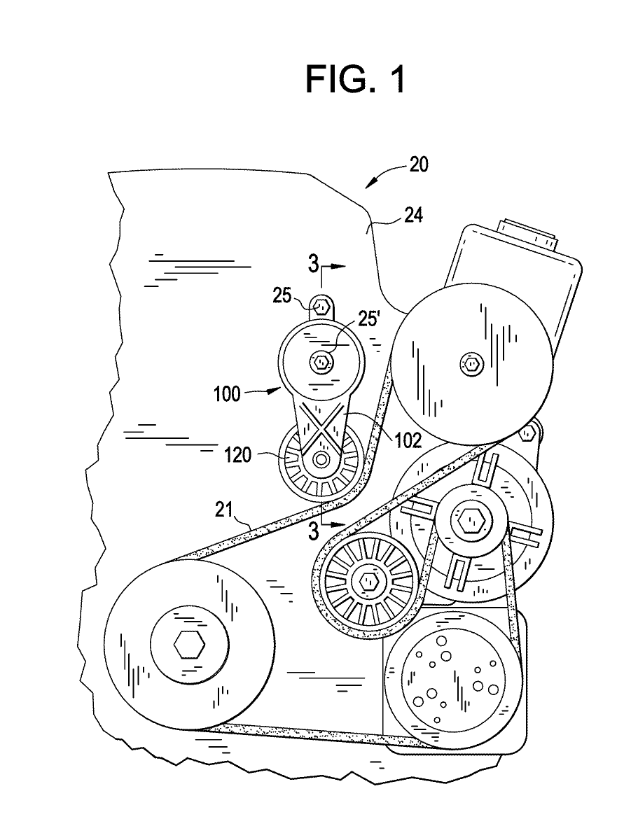

Referring now to FIG. 1, an engine is generally indicated by the reference numeral 20 and utilizes an endless power transmitting element 21 for driving a plurality of driven accessories as is well known in the art. The belt tensioner of this invention, generally designated as 100, is utilized to provide a tensioning force on the endless power transmitting element 21. The endless power transmission element 21 may be of any suitable type known in the art. The tensioner 100 is configured to be fixed to a mounting bracket or support structure 24 of the engine 20 by a plurality of fasteners 25. The fasteners may be bolts, screws, welds, or any other suitable fastener known in the art that will hold the tensioner in place during operation of the engine. The mounting bracket or supporting structure 24 may be of any configuration and include any number of openings for receiving the fasteners 25.

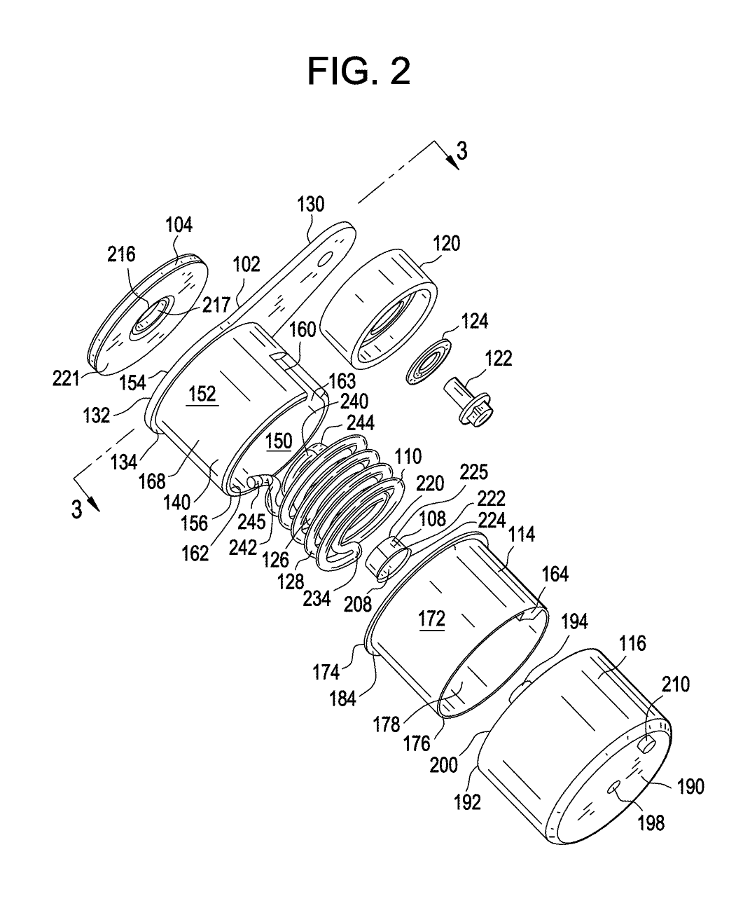

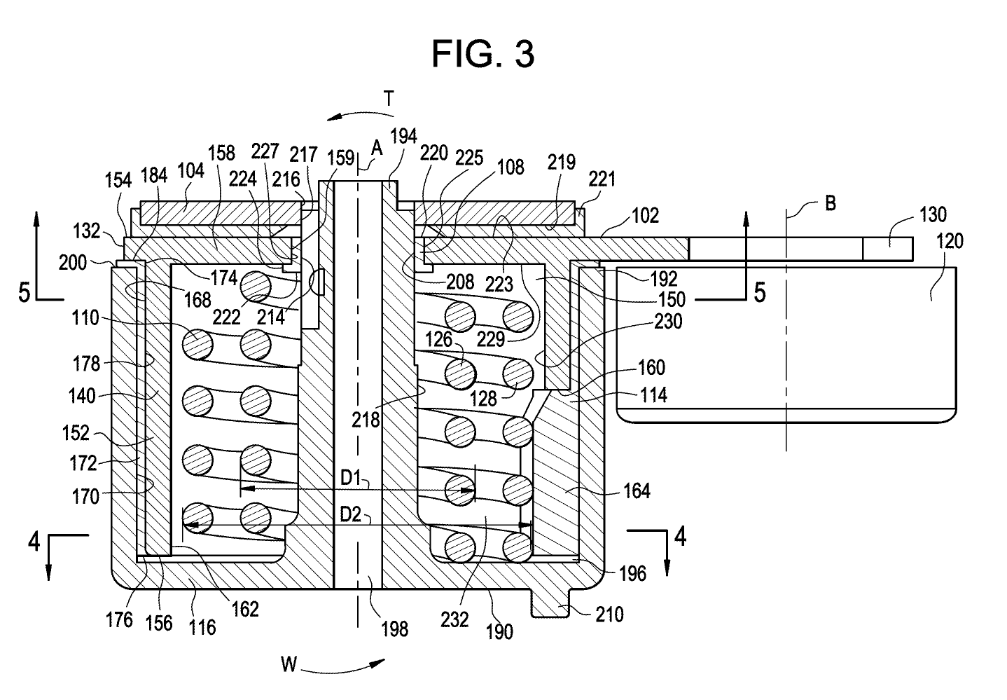

Referring to FIGS. 2-3, the tensioner 100 includes a tensioner arm 102 rotatable about a first axis A in the tensioning direction T and in the winding direction W. The tensioner 100 also includes a cap 104, a pivot bushing 108, a spring 110, a bushing 114, and a support member 116. The spring 110 includes at least one inner winding 126 and an outer winding 128. The arm 102 includes a pulley 120 rotatably mounted to a first end 130 of the arm 102 for rotation about a second axis B that is spaced from and parallel to the first axis A (the pulley 120 is not cross-sectioned in FIG. 3). The pulley 120 may be coupled to the arm 102 with a fastener 122 such as, for example, a bolt, screw, pin, or rivet. The fastener 122 may secure a dust cover 124 to the pulley 120.

An arm arbor 140 is located at a second end 132 of the arm 102. The arm arbor 140 extends from a bottom surface 134 the arm 102 about the first axis A. The arm arbor 140 may include a sleeve 152 that has a first end 154 (shown in FIG. 3) and an open second end 156. As seen in FIG. 3, the first end 154 defines a partial top 158. The partial top 158 defines an opening 159 for receiving the pivot bushing 108 and a pivot shaft 194 of the support member 116. The opening 159 of the first end 154 is smaller in size when compared to an opening 162 defined by the second open end 156. The partial top 158 helps stabilize or provide rigidity to the first end 154 of the sleeve 152 and provides the arm arbor 140 with fixed dimensions. In one embodiment, the sleeve 152 is substantially cylindrical and has a fixed diameter.

The sleeve 152 defines a cavity 150 for receiving the spring 110. Within the sleeve 152 one or more open ended slots 160 are present that extend therethrough, i.e., the slots 160 are open from the exterior surface of the arm arbor 140 and extend into an interior of the arm arbor 140. The slots 160 may include an open end 163 (seen in FIG. 2). The open end 163 of the slots 160 are located along the second open end 156 of the sleeve 152 such that a periphery of the second open end 156 of the sleeve 152 is circumferentially discontinuous. Upon assembly of the tensioner 100, the second end 156 of the sleeve 152 may be closed by the support member 116. The cap 104 and the support member 116 may enclose the components of the tensioner 100 such as the pivot bushing 108, the spring 110, the bushing 114, and the arm arbor 140. The cap 104 and the support member 116 protect the pivot bushing 108, the spring 110, the bushing 114, and the arm arbor 140 from contaminants.

The bushing 114 is positioned or positionable between an outer surface 168 of the arm arbor 140 and an interior surface 170 (shown in FIG. 3) of the support member 116. The bushing 114 includes a sleeve 172 having a first open end 174 and a second open end 176 and one or more protrusions 164 extending inward from an interior surface 178 of the sleeve 172 toward the first axis A (shown in FIG. 3). In one embodiment, the sleeve 172 is generally cylindrical. In the exemplary embodiment as shown in FIGS. 2-3, the bushing 114 includes a single protrusion 164, and the arm arbor 140 includes a single slot 160, however it is understood that the bushing 114 may include any number of protrusions 164, and the arm arbor 140 may include any number of slots 160. The number of protrusions 164 preferably matches the number of slots 160 in the arm arbor 140 such that the bushing 114 is mateable with the arm arbor 140, where the protrusions 164 are received in the slots 160. Accordingly, the protrusions 164 are shaped to mate with the slots 160 of the arm arbor 140. In one embodiment, the protrusions 164 are also dimensioned to extend into the cavity 150 of the arm arbor 140 (shown in FIG. 3).

In one embodiment, the bushing 114 may be constructed of a generally elastic material to allow for the bushing 114 to expand in a radially outward direction with respect to the first axis A. In an alternative embodiment, the bushing 114 may include a slit (not shown), which extends from the first open end 174 to the second open end 176. The slit may allow the bushing 114 to expand in the radially outward direction with respect to the first axis A.

As best seen in FIG. 3, in one embodiment the support member 116 has a closed end 190 and an open end 192. The pivot shaft 194 of the support member 116 extends from the closed end 190 towards the open end 192. In one embodiment, the pivot shaft 194 may extend beyond the open end 192 of the support member 116. The support member 116 also includes a cavity 196 that is defined by the closed end 190 and the open end 192. The arm arbor 140 is received by the cavity 196 of the support member 116. The arm 102 is rotatably mounted to the pivot shaft 194 of the support member 116, where the pivot shaft 194 defines the first axis A. The support member 116 may facilitate mounting the tensioner 100 in place relative to the power transmitting element 21 (shown in FIG. 1). In one embodiment, the pivot shaft 194 is generally centrally positioned within the cavity 196 of the support member 116, and has an axially extending opening 198 or bore that may receive a bolt, screw, pin, or other fastener 25′ (shown in FIG. 1) to hold the assembled tensioner 100 together and/or to mount the tensioner 100 to a surface relative to the power transmitting element 21. In one embodiment, the support member 116 may include a positioning pin 210 located on an exterior surface of the closed end 190 of the support member 116. The mounting bracket or supporting structure 24 of the engine 20 (shown FIG. 1) may include a receptacle (not illustrated) that receives the positioning pin 210. While the embodiment as shown in FIGS. 1-5 illustrate the support member 116 being secured to the supporting structure 24 by the fastener 25′ received by the bore 198, it is understood various other approaches may be used as well to secure the support member 116 to the supporting structure 24.

The support member 116 may also receive and/or house at least part of the pivot bushing 108, the bushing 114, the hub 106, and the spring 110 within the cavity 196. In one embodiment, the support member 116 may include an upper rim 200 extending about the periphery of the open end 192 of the cavity 196. The bushing 114 may include an upper flange 184 that extends outward about the periphery of the first open end 174. The flange 184 of the bushing 114 may be seated against the upper rim 200 of the support member 116.

The cap 104 includes a generally centrally located bore 216 for receiving the pivot shaft 194, where the cap 104 is fixedly attached to the support member 116. Specifically, an inner surface 217 of the bore 216 may be fixedly attached to an outer surface 218 of the pivot shaft 194. In one embodiment, the inner surface 217 of the bore 216 may be fixedly attached to the outer surface 218 of the pivot shaft 194 by radial riveting, however it is to be understood that any type of joining approach for fixedly attaching the inner surface 217 of the bore 216 to the outer surface 218 of the pivot shaft 194 may be used as well. In one embodiment, a bearing material 221 covers at least a portion of a lower surface 219 of the cap 104 (the lower surface 219 is seen in FIG. 3). The bearing material 221 may reduce friction between the cap 204 and an upper surface 223 of the partial top 158. The bearing material 221 may be any type of material that is used to reduce friction such as, for example, nylon 6-6.

As best seen in FIG. 3, the pivot shaft 194 may be received by the pivot bushing 108, where an inner surface 208 of the pivot bushing 108 contacts the outer surface 218 of the pivot shaft 194. The opening 159 of the first end 158 of the arm arbor 140 receives the pivot bushing 108, where an outer surface 225 of the bushing 225 contacts an inner surface 227 of the opening 159. The arm arbor 140 is rotatable about the pivot shaft 194. The pivot bushing 108 may be used reduce wear of both the pivot shaft 194 and the arm arbor 140. Referring to both FIGS. 2-3, in one embodiment the pivot bushing 108 includes an upper opening 220 and a lower opening 222, where a flange 224 extends radially outward about a periphery of the lower opening 222. An inner surface 229 of the first end 158 of the arm arbor 140 may be seated against the flange 224 of the pivot bushing 108.

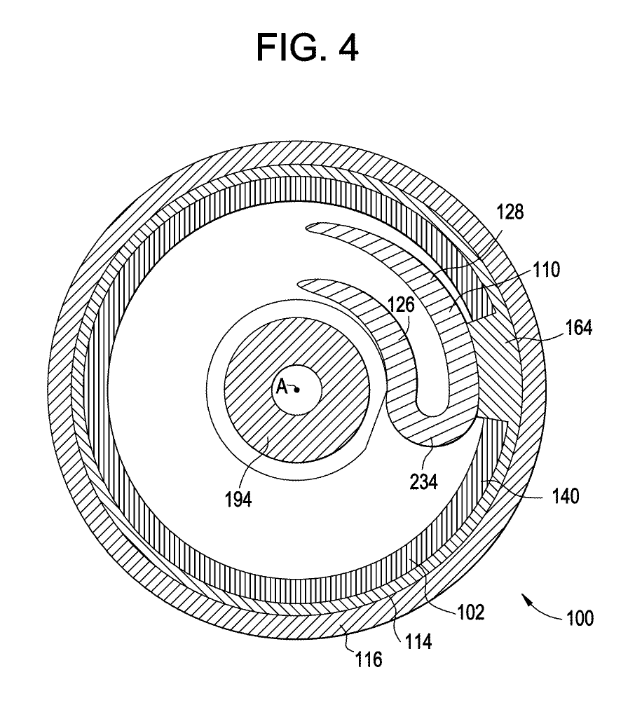

The spring 110 is a single, unitary spring having multiple windings. In the exemplary embodiment as shown, the spring 110 includes at least one inner winding 126 and the outer winding 128, where the inner winding 126 is positioned radially inward from the outer winding 128 with respect to the first axis A. Referring specifically to FIGS. 2 and 4, the spring 110 includes a transition zone 234 that connects the inner winding 126 with the outer winding 128. The coil of the spring 110 bends or transitions between the inner winding 126 and the outer winding 128 in the transition zone 234.

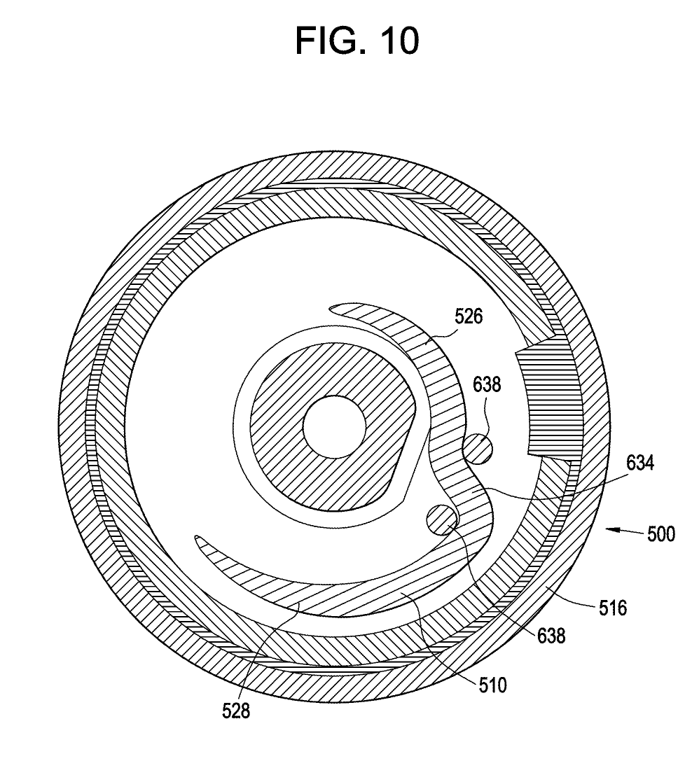

FIGS. 2-4 illustrate the inner winding 126 and the outer winding 128 both wound in the same direction, where the transition zone 234 of the coil of the spring 110 turns or bends about one hundred and eighty degrees between the inner winding 126 and the outer winding 128. It should be noted that while a one hundred and eighty degree turn is shown in FIGS. 2 and 4, the transition zone 234 may include other configurations or shapes as well, and the inner winding 126 and the outer winding 128 may be wound in opposite directions as well. For example, FIG. 10 illustrates a spring 510 having a transition zone 634, as well as an inner winding 526 and an outer winding 528 that are wound in opposite directions, which is discussed in greater detail below. Moreover, it should also be noted that while only one inner winding 126 is illustrated, it is to be understood that the spring 110 may include multiple inner windings as well, where each of the inner windings may be nested within the outer winding, or within the other inner winding. Specifically, the inner windings may have graduated coil diameters where one of the inner windings may fit within another inner windings that that has a slightly larger coil diameter.

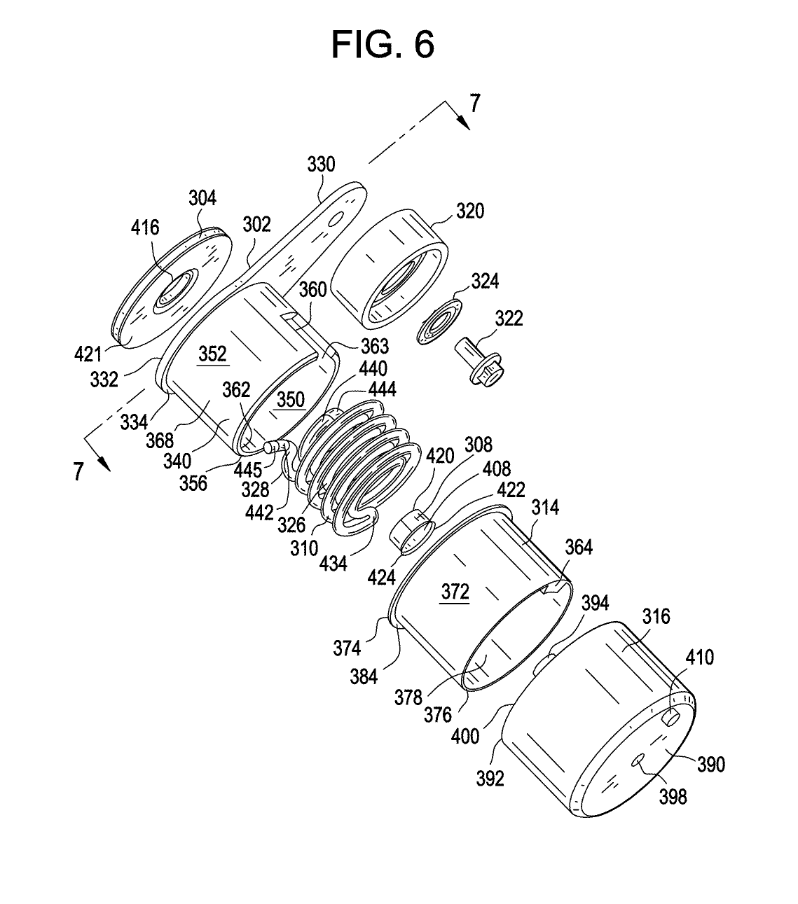

The spring 110 in FIGS. 2-4 is fixedly attached to the arm arbor 140 and the support member 116. The inner winding 126 and the outer winding 128 are connected to one another in a series configuration and operate together as a single winding. Specifically, the transition zone 234 (best seen in FIG. 4) connects the inner winding 126 to the outer winding 128, where torque is shared between the inner winding 126 to the outer winding 128. The inner winding 126 and the outer winding 128 cooperate together to urge the arm 102 to rotate about the first axis A about the pivot shaft 194 of the support member 116. Although a series configuration is illustrated in FIGS. 2-5, it is to be understood that the inner winding 126 to the outer winding 128 may be connected to one another in a parallel configuration as well, which is described in greater detail below with illustration in FIGS. 6-10.

As best seen in FIG. 3, both the inner winding 126 and the outer winding 128 are seated within the cavity 150 in the arm arbor 140. The coils of the outer winding 128 are juxtaposed with an inner surface 230 of the arm arbor 140. The coils of the outer winding 128 are also juxtaposed with the protrusion 164 of the bushing 108. The coils of the inner winding 126 surround the outer surface 218 of the pivot shaft 194. The inner winding 126 includes an inner winding coil diameter D1, and the outer winding 128 includes an outer winding coil diameter D2. The inner winding coil diameter D1 is less than the outer winding coil diameter D2 such that at least a portion of the inner winding 126 fits within or is received by the outer winding 128. That is, the coils of the outer winding 128 define a cavity 232 that receives at least a portion of the inner winding 126. Thus, at least a portion of the coils of the inner winding 126 are surrounded by the coils of the outer winding 128, and the inner winding 126 is nested at least partially within the outer winding 128.

In one embodiment, the inner winding 126 and the outer winding 128 are both wound in the tensioning direction T. Accordingly, when the arm 102 rotates about the first axis A in the winding direction W in response to belt loading or other prevailing forces on the power transmitting element 21 (shown in FIG. 1), the inner winding 126 and the outer winding 128 are unwound. Thus, the inner winding 126 and the outer winding 128 will both expand radially outward away from the first axis A. It is noted that the unwinding of the inner winding 126 and the outer winding 128 of the spring 110 as the arm 102 rotates about the first axis A is in the winding direction W is typically uncharacteristic for tensioners. When the belt loading or other prevailing forces on the power transmitting element 21 dissipate, the arm 102 rotates about the first axis A in the tensioning direction T. Accordingly, the inner winding 126 and the outer winding 128 are wound. Thus, the inner winding 126 and the outer winding 128 will constrict radially inward towards the first axis A.

Although the inner winding 126 and the outer winding 128 are both discussed being wound in the tensioning direction T, it is to be understood that inner winding 126 and the outer winding 128 may be wound in other configurations as well. For example, in an alternative embodiment the inner winding 126 and the outer winding 128 may both be wound in the winding direction W instead. Accordingly, when the arm 102 rotates about the first axis A in the winding direction W in response to belt loading or other prevailing forces on the power transmitting element 21 (shown in FIG. 1), the inner winding 126 and the outer winding 128 are wound. When the belt loading or other prevailing forces on the power transmitting element 21 dissipate, the arm 102 rotates about the first axis A in the tensioning direction T. Accordingly, the inner winding 126 and the outer winding 128 are unwound.

The specific winding direction of the inner winding 126 and the outer winding 128 may be determined based on the tensioning force the tensioner 100 is required to exert on the endless power transmitting element 21 (shown in FIG. 1). The winding direction of the inner winding 126 and the outer winding 126 may also be determined based on a damper or damping mechanism, for example a frictional damper, that is incorporated with the tensioner 100. In one embodiment, the frictional damper is used to resist movement of the power transmitting element 21, without affecting rotation of the tensioner 100 to tension the power transmitting element 21. In another embodiment, the frictional damper may be used to resist rotation of the tensioner 100 to tension the power transmitting element 21, without affecting rotation of the tensioner 100 in response to a prevailing force of the power transmitting element 21. These types of dampers, which dampen rotation of the tensioner 100 in one direction, are referred to as asymmetric dampers.

Although FIGS. 2-5 illustrate the inner winding 126 and the outer winding 128 wound in the same direction, it is to be understood that the inner winding 126 and the outer winding 128 may be wound in opposing directions as well. For example, in another embodiment the inner winding 126 may be wound in the winding direction W and the outer winding 128 may be wound in the tensioning direction T to provide asymmetric damping to the tensioner. Referring to FIGS. 2-3, as the arm 102 rotates in the winding direction W, the outer winding 128 is unwound and the coils of the outer winding 128 expand outward. As the outer winding 128 unwinds, the outer winding coil diameter D2 will increase, and the coils of the outer winding 128 will expand into the protrusion 164 of the bushing 114, thereby directing the bushing 114 radially outward relative to the arm arbor 140. The bushing 114 will expand radially and frictionally engage with the interior surface 170 of the support member 116, while the arm arbor 140 remains stationary in the radial direction and does not expand. Thus, the expansion of the outer winding 128 applies frictional damping in the winding direction W.

As the arm rotates in the winding direction W, the inner winding 136 may be wound up and the coils of the inner winding 136 expand inward. As the inner winding 136 winds up, the inner winding coil diameter D1 will decrease, and the coils of the inner winding 136 will expand into a pivot shaft bushing (not illustrated) that is placed around the outer surface 218 of the pivot shaft 194. The pivot shaft bushing radially contracts and frictionally engages with the outer surface 218 of the pivot shaft 194. Thus, the contraction of the inner winding 136 may also apply frictional damping in the winding direction W.

In another embodiment, the inner winding 126 and the outer winding 128 are wound to provide frictional damping to the tensioner 100 in two directions. Specifically, the frictional damper is used to resist movement of the power transmitting element 21 as well rotation of the tensioner 100 to tension the power transmitting element 21. These types of dampers, which dampen rotation of the tensioner 100 in two directions, are referred to as symmetric dampers. For example, in one embodiment the inner winding 126 and the outer winding 128 may both be wound in the tensioning direction T to provide symmetric damping. Specifically, as the arm 102 rotates in the winding direction W, the outer winding 128 is unwound and the coils of the outer winding 128 expand outward and cause the bushing 114 to frictionally engage with the interior surface 170 of the support member 116. Expansion of the outer winding 128 provides frictional damping to the belt tensioner 100 in the winding direction W. Likewise, as the arm 102 rotates in the tensioning direction T, the inner winding 126 is wound and the coils of the inner winding 126 expand inward and cause a pivot shaft bushing (not shown) to frictionally engage with the outer surface 218 of the pivot shaft 194. Contraction of the inner winding 126 provides frictional damping to the belt tensioner 100 in the tensioning direction T. Although winding both the inner winding 126 and the outer winding 128 in the tensioning direction T is discussed, it is understood that the inner winding 126 and the outer winding 128 may be wound in a variety of configurations to provide symmetric damping.

The spring 110 may be any type of torsional spring having any shape and/or configuration. In one embodiment, the spring 110 may be a round-wire spring. In another embodiment, the spring 110 may be a square or rectangular spring or a square or rectangular coil spring. One of skill in the art will appreciate that these various torsional springs may require alternate spring end engagement points within the tensioner to provide secure attachments so that the spring 110 winds and unwinds appropriately to bias the arm 102.

Referring to FIGS. 2-5, the spring 110 is fixedly attached and grounded to the support member 116. The spring 110 is also connected to the arm 102. The spring 110 includes a first end portion 240 and a second end portion 242. The inner winding 126 of the spring 110 terminates at the first end portion 240, and the outer winding 128 of the spring 110 terminates at the second end portion 242. The first end portion 240 of the inner winding 126 is fixedly attached to the support member 116, and the second end portion 242 of the outer winding 128 is connected to the arm 102. In one embodiment, the first end portion 240 may include a tang 244 that extends inward towards the first axis A, and the second end portion 242 may include a tang 245 that extends outward away from the first axis A.

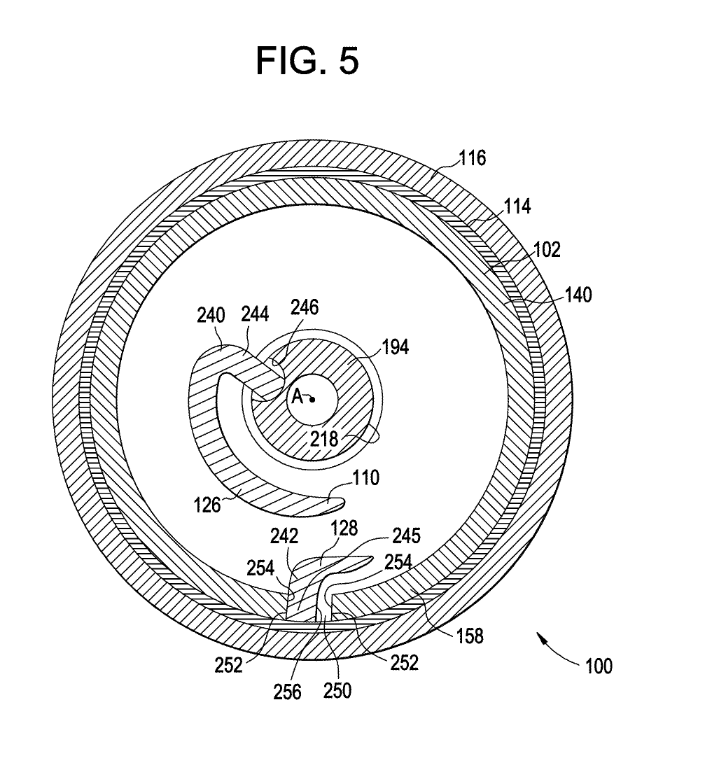

As best seen in FIG. 5, the support member 116 includes a receptacle 246 that is located along the outer surface 218 of the pivot shaft 194. The receptacle 246 receives a portion of the tang 244 of the inner winding 126, and fixedly attaches the inner winding 126 of the spring 110 to the support member 116. It is understood that while the receptacle 246 is illustrated in FIG. 5, the support member 116 may include other types of retaining features as well such as, for example, a bracket, or any other type of feature that is configured to fixedly attach the first end portion 240 of the inner winding 126 to the support member 116.

A portion of the tang 245 of the outer winding 128 may be disposed within an opening 250 that is located along the partial top 158 of the arm arbor 140. The opening 250 defines two generally opposing abutment features 252. The two abutment features 252 each provide a generally planar surface 254, where an outer surface 256 of the tang 245 of the second end portion 242 abuts directly against one of the planar surfaces 254 depending on the direction of expansion of the outer winding 128. Although the planar surface 254 is shown in FIG. 5, it is to be understood that in an alternative embodiment the abutment feature 252 may be a sleeve, a bracket, a recess, or another receptacle that the tang 245 of the outer winding 128 fits into to connect the outer winding 128 to the arm 102.

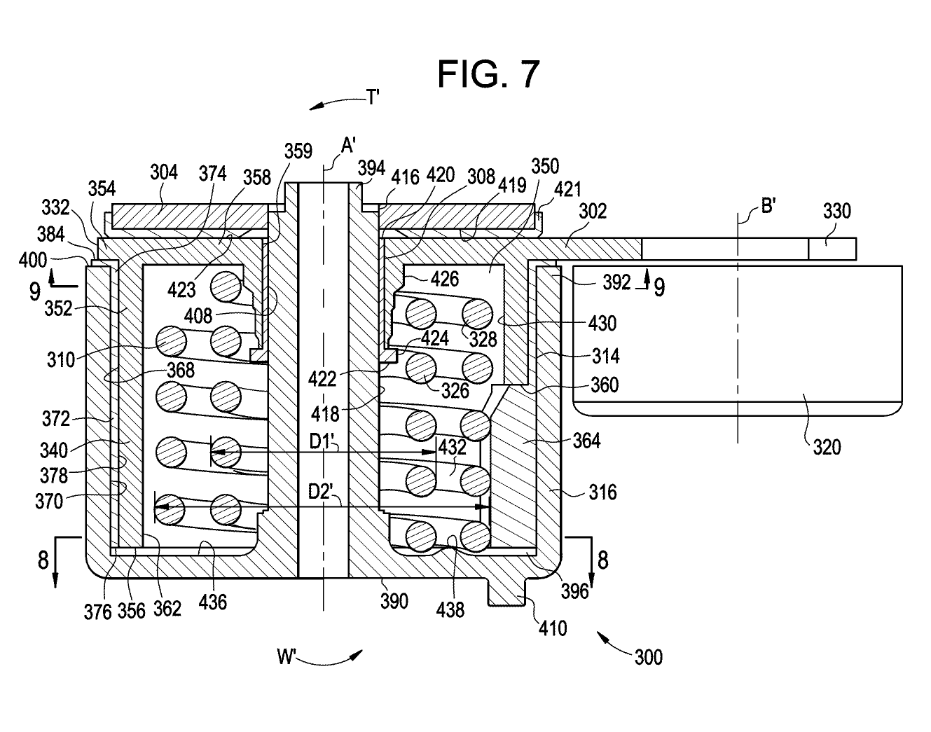

FIGS. 6-9 illustrate another embodiment of a tensioner 300, where an inner winding 326 and an outer winding 328 of a spring 310 are connected together in the parallel configuration. Referring to FIGS. 6-7, the tensioner 300 includes a tensioner arm 302 rotatable about a first axis A′ in the tensioning direction T′ and in the winding direction W′. The tensioner 300 also includes a cap 304, a pivot bushing 308, a bushing 314, and a support member 316. The arm 302 includes a pulley 320 rotatably mounted to a first end 330 of the arm 302 for rotation about a second axis B′ that is spaced from and parallel to a first axis A′. The pulley 320 may be coupled to the arm 302 with a fastener 322 such as, for example, a bolt, screw, pin, or rivet. The fastener 322 may secure a dust cover 324 to the pulley 320. It should be noted that the pulley 320 is not cross-sectioned in FIG. 7.

An arm arbor 340 is located at a second end 332 of the arm 302. The arm arbor 340 extends from a bottom surface 334 the arm 302 about the first axis A′. The arm arbor 340 may include a sleeve 352 that has a first end 354 (shown in FIG. 7) and an open second end 356. As seen in FIG. 7, the first end 354 defines a partial top 358. The partial top 358 defines an opening 359 for receiving the pivot bushing 308 and a pivot shaft 394 of the support member 316. The opening 359 of the first end 354 is smaller in size when compared to than an opening 362 defined by the second open end 356.

The sleeve 352 defines a cavity 350 for receiving the spring 310. Within the sleeve 352 one or more open ended slots 360 are present that extend therethrough, i.e., the slots 360 are open from the exterior surface of the arm arbor 340 and extend into an interior of the arm arbor 340. The slots 360 may include an open end 363 (shown in FIG. 7). The open end 363 of the slots 360 are located along the second open end 356 of the sleeve 352 such that a periphery of the second open end 356 of the sleeve 352 is circumferentially discontinuous.

The bushing 314 is positioned or positionable between an outer surface 368 of the arm arbor 340 and an interior surface 370 (shown in FIG. 7) of the support member 316. The bushing 314 includes a sleeve 372 having a first open end 374 and a second open end 376 and one or more protrusions 364 extending inward from an interior surface 378 of the sleeve 372 toward the first axis A′. In the exemplary embodiment as shown in FIGS. 6-7, the bushing 314 includes a single protrusion 364, and the arm arbor 340 includes a single slot 360, however it is understood that the bushing 314 may include any number of protrusions 364, and the arm arbor 340 may include any number of slots 360.

As best seen in FIG. 7, in one embodiment the support member 316 has a closed end 390 and an open end 392. The pivot shaft 394 extends from the closed end 390 towards the open end 392. In one embodiment, the pivot shaft 394 may extend beyond the open end 392 of the support member 316. The support member 316 also includes a cavity 396 that is defined by the closed end 390 and the open end 392. The arm arbor 340 is received by the cavity 396 of the support member 316. The arm 302 is rotatably mounted to the pivot shaft 394 of the support member 316, where the pivot shaft 394 defines the first axis A′. The support member 316 may facilitate mounting the tensioner 300 in place relative to the power transmitting element 21 (shown in FIG. 1). In one embodiment, the support member 316 may include a positioning pin 410 located on an exterior surface of the closed end 390 of the support member 316.

Referring to both FIGS. 6-7, in one embodiment the support member 316 may include an upper rim 400 extending about the periphery of the open end 392 of the cavity 396. The bushing 314 may include an upper flange 384 that extends outward about the periphery of the first open end 374. The flange 384 of the bushing 314 may be seated against the upper rim 400 of the support member 316.

The cap 304 includes a generally centrally located bore 416 for receiving the pivot shaft 394, where the cap 304 is fixedly attached to the support member 316. In one embodiment, a lower surface 419 of the cap 304 (shown in FIG. 7) may include a bearing material 421. The bearing material 421 may be used to reduce friction between the cap 304 and an upper surface 423 of the partial top 358.

As best seen in FIG. 7, the pivot shaft 394 may be received by the pivot bushing 308, where an inner surface 408 of the pivot bushing 308 contacts the outer surface 418 of the pivot shaft 394. Referring to both FIGS. 6-7, in one embodiment the pivot bushing 308 includes an upper opening 420 and a lower opening 422, where a flange 424 extends radially outward about a periphery of the lower opening 422. The opening 359 of the first end 358 of the partial top 358 extends inwardly into the cavity 350 of the arm arbor 340, and defines a rim 426 (shown in FIG. 7). The rim 426 of the partial top 358 may be seated against the flange 424 of the pivot bushing 308.

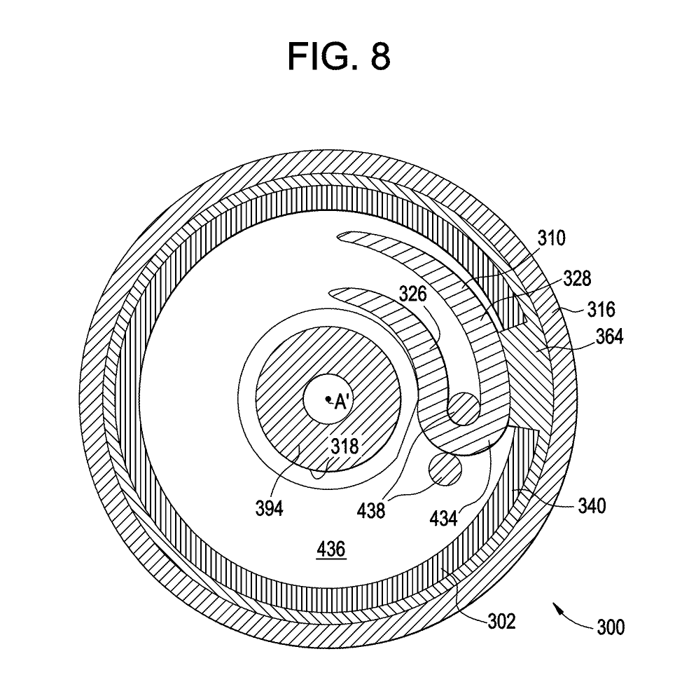

Similar to the embodiment as shown in FIGS. 2-5, the spring 310 is a single, unitary spring having multiple windings. Referring to FIGS. 6 and 8, the spring 310 includes a transition zone 434, where the coil of the spring 310 bends between the inner winding 326 and the outer winding 328. A bottom surface 436 of the support member 316 includes a retaining feature 438 for securing the spring 310 at the transition zone 434. As best seen in FIG. 8, in one embodiment the securing feature 438 may be two generally circular raised protrusions (in cross-section), where the transition zone 434 of the spring 310 is wedged between the two protrusions. The retaining feature 438 secures and fixedly attaches both the inner winding 326 and the outer winding 328 of the spring 310 to the support member 316. It is to be understood that while FIG. 8 illustrates the retaining feature 438 as two raised protrusions, it is understood that the retaining feature 438 may include any type of mechanism that secures the inner winding 326 and the outer winding 328 to the support member 316 such as, for example, a bracket.

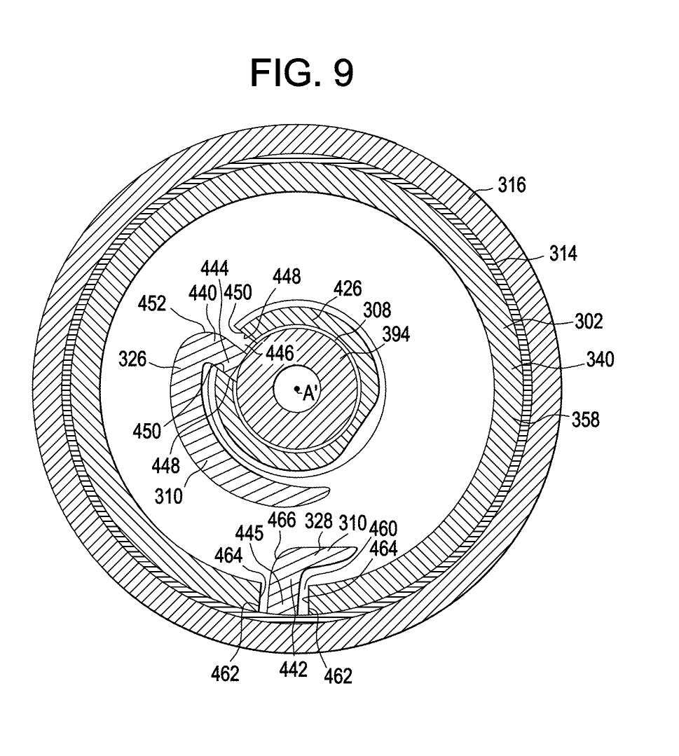

Referring to FIGS. 6-9, the inner winding 326 and the outer winding 328 are connected to one another in the parallel configuration, where both the inner winding 326 and the outer winding 328 are fixedly attached to the support member 316. The inner winding 326 and the outer winding 328 are also both connected to the arm arbor 340. Specifically, the transition zone 434 (shown in FIG. 8) of the spring 310 fixedly attaches both the inner winding 326 and the outer winding 328 to the support member 316. As seen in FIG. 9, both the inner winding 326 and the outer winding 328 may include tangs that are both connected to the arm 302, which is discussed in greater detail below.

In the exemplary embodiment as shown in FIGS. 6-9, the inner winding 326 and the outer winding 328 are both wound in the same direction, and the transition zone 434 of the coil of the spring 310 turns about one hundred and eighty degrees between the inner winding 326 and the outer winding 328. It should be noted that while a one hundred and eighty degree turn is shown in FIGS. 6 and 8, the transition zone 428 may include other configurations or shapes, and the inner winding 326 and the outer winding 428 may be wound in opposite directions. For example, FIG. 10 illustrates an alternative embodiment of a tensioner 500 including the spring 510. The inner winding 526 and the outer winding 528 of the spring 510 are wound in opposing directions. The spring 510 also includes a transition zone 634. In the embodiment as shown in FIG. 10, the transition zone 634 has a turn that is about forty-five degrees. Similar to the embodiment as shown in FIG. 8, a support member 516 includes a retaining feature 638 that includes two generally circular raised protrusions (in cross-section. The transition zone 634 of the spring 510 is wedged between the two protrusions.

Referring to FIG. 7, both the inner winding 326 and the outer winding 328 are seated within the cavity 350 in the arm arbor 340. The coils of the outer winding 328 are juxtaposed with an inner surface 430 of the arm arbor 340. The coils of the outer winding 328 are also juxtaposed with the protrusion 364 of the bushing 314. The coils of the inner winding 326 surround the outer surface 418 of the pivot shaft 394. The inner winding 326 includes an inner winding coil diameter D1′, and the outer winding 328 includes an outer winding coil diameter D2′. The inner winding coil diameter D1′ is less than the outer winding coil diameter D2′ such that at least a portion of the inner winding 326 fits within or is received by the outer winding 328. That is, the coils of the outer winding 328 define a cavity 432 that receives at least a portion of the inner winding 326. Thus, at least a portion of the coils of the inner winding 326 are surrounded by the coils of the outer winding 328, and the inner winding 326 is nested at least partially within the outer winding 328.

Referring to FIGS. 6-9, in one embodiment the inner winding 326 and the outer winding 328 are both wound in the tensioning direction T′. However, it is to be understood that inner winding 326 and the outer winding 328 may be wound in other configurations as well. For example, in an alternative embodiment the inner winding 326 and the outer winding 328 may both be wound in the winding direction W′ instead. In another embodiment, the inner winding 326 and the outer winding 328 may be wound in opposing directions. For example, the inner winding 326 may be wound in the winding direction W′ and the outer winding 328 may be wound in the tensioning direction T′.

Similar to the embodiment as illustrated in FIGS. 2-5, the specific winding direction of the inner winding 326 and the outer winding 328 may be determined based on the tensioning force the tensioner 300 is required to exert on the endless power transmitting element 21 (shown in FIG. 1). The winding direction of the inner winding 326 and the outer winding 328 may also be determined based on a damper or damping mechanism, for example a frictional damper, that is incorporated with the tensioner 300. Specifically, similar to the embodiment as shown in FIGS. 2-5 the inner winding 326 and the outer winding 328 may be wound in a variety of configurations to provide asymmetric or symmetric damping.

Referring specifically to FIGS. 6 and 9, the spring 310 includes a first end portion 440 that is connected to the support member 316 and a second end portion 442 that connects to the arm 302. The inner winding 326 of the spring 310 terminates at the first end portion 440, and the outer winding 328 of the spring 310 terminates at the second end portion 442. In one embodiment, the first end portion 440 may include a tang 444 that extends inward towards the first axis A′, and the second end portion 442 may include a tang 445 that extends outward away from the first axis A′.

As best seen in FIG. 9, the flange 426 of the partial top 358 of the arm arbor 340 includes an opening 446. The opening 446 defines two generally opposing abutment features 448. The two abutment features 448 each provide a generally planar surface 450, where an outer surface 452 of the tang 444 of the first end portion 440 of the spring 310 abuts directly against one of the planar surfaces 450 depending on the direction of expansion of the inner winding 326.

A portion of the tang 445 of the outer winding 328 may be disposed within an opening 460 that is located along the partial top 358 of the arm arbor 340. The opening 460 defines two generally opposing abutment features 462. The two abutment features 462 each provide a generally planar surface 464, where an outer surface 466 of the tang 245 of the second end portion 442 of the spring 310 abuts directly against one of the planar surfaces 464 depending on the direction of expansion of the outer winding 328.

Referring generally to the Figures, the inner windings and the outer windings of the spring 110 are connected with one another in either a series configuration (shown in FIGS. 2-5) or a parallel configuration (shown in FIGS. 6-10). Arranging the inner windings and the outer windings in the series configuration may result in a lower spring rate when compared to the parallel configuration. Thus, the series configuration is typically used in applications where the arm of the tensioner requires longer travel or rotation at a generally steady-state torque. In contrast, arranging the inner windings and the outer windings in the parallel configuration may result in a higher spring rate when compared to the series configuration. Thus, the parallel configuration is typically used in applications where the arm of the tensioner requires shorter travel and a relatively quick take-up or rotation of the arm is needed.

The multiple nested windings of the disclosed torsion springs may be beneficial in applications where relatively large torsional loads (e.g., typically greater than about 90 Nm for a 100 millimeter diameter package) are experienced by the power transmitting element, especially if packaging space is limited. Some types of belt tensioners that are currently available include a single torsional spring that has an increased height and/or width. Specifically, the height and/or width of the torsional spring is increased in an effort to counteract relatively large torsional loads that may be experienced by a belt. However, these types of belt tensioners also require more packaging space due to the increased height and/or width of the torsion spring. In contrast, the tensioner as disclosed utilizes a torsion spring that includes multiple windings nested within one another. The multiple windings require less packaging space when compared to a single torsion spring having an increased height and/or width.

The embodiments of this invention shown in the drawing and described above are exemplary of numerous embodiments that may be made within the scope of the appended claims. It is contemplated that numerous other configurations of the tensioner may be created taking advantage of the disclosed approach. In short, it is the applicant's intention that the scope of the patent issuing herefrom will be limited only by the scope of the appended claims.

What is claimed is:

1. A tensioner comprising:
an arm rotatable about a first axis; and
a spring coupled to the arm, the spring comprising:
an outer winding having an outer coil that defines an outer diameter;
at least one inner winding having an inner coil that defines an inner diameter, the inner diameter of the inner coil being less than the outer diameter of the outer coil such that at least a portion of the inner winding of the spring is received by the outer winding of the spring, and wherein the outer winding and the inner winding of the spring both urge the arm to rotate about the first axis into tensioning engagement with a power transmitting element; and
a transition zone that connects the inner winding with the outer winding.

2. The tensioner of claim 1 wherein the arm comprises an arm arbor.

3. The tensioner of claim 2 further comprising a support member for receiving the arm arbor and the spring.

4. The tensioner of claim 3 wherein the support member includes a retaining feature that fixedly attaches a portion of the spring to the support member.

5. The tensioner of claim 4 wherein an end portion of the inner winding is connected to the arm arbor.

6. The tensioner of claim 4 wherein an end portion of the outer winding is connected to the arm arbor.

7. The tensioner of claim 3 wherein an end portion of the inner winding is fixedly attached to the support member.

8. The tensioner of claim 3 wherein an end portion of the outer winding is connected to the arm arbor.

9. The tensioner of claim 3 wherein the support member is stationary and includes a pivot shaft that defines the first axis, wherein the arm is rotatably mounted to the pivot shaft.

10. The tensioner of claim 1 wherein a portion of the spring bends between the inner winding and the outer winding in the transition zone.

11. The tensioner of claim 1 wherein the inner winding and the outer winding are wound in opposing directions.

12. The tensioner of claim 1 wherein the inner winding and the outer winding are both wound in a same direction.

13. A tensioner comprising:
a support member including a pivot shaft that defines a first axis;
an arm having an arm arbor that is mounted on the pivot shaft for rotatable movement of the arm about the first axis, the arm arbor defining a cavity;
a spring received in the cavity of the arm arbor and coupled to the arm, the spring comprising:
an outer winding having an outer coil that defines an outer diameter;
at least one inner winding having an inner coil that defines an inner diameter, the inner diameter of the inner coil being less than the outer diameter of the outer coil such that at least a portion of the inner winding of the spring is received by the outer winding of the spring, and wherein the outer winding and the inner winding of the spring both urge the arm arbor to rotate about the first axis into tensioning engagement with a power transmitting element; and
a transition zone connecting the inner winding with the outer winding, wherein a portion of the spring bends between the inner winding and the outer winding in the transition zone.

14. The tensioner of claim 13 wherein the support member includes a retaining feature that fixedly attaches a portion of the spring to the support member.

15. The tensioner of claim 14 wherein an end portion of the inner winding is connected to the arm arbor.

16. The tensioner of claim 14 wherein an end portion of the outer winding is connected to the arm arbor.

17. The tensioner of claim 13 wherein an end portion of the inner winding is fixedly attached to the support member.

18. The tensioner of claim 13 wherein an end portion of the outer winding is connected to the arm arbor.

19. The tensioner of claim 13 wherein the inner winding and the outer winding are wound in opposing directions.

20. The tensioner of claim 13 wherein the inner winding and the outer winding are both wound in a same direction.
